(19) United States
(12) Patent Application Publication
(10) Pub. No.: US 2026/0252803 A1
(43) Pub. Date: Aug. 27, 2026

(54) ALIGNING AUTO-GENERATED PATENT APPLICATION CONTENT WITH ATTORNEY INTENT

(71) Applicant: Paximal, Inc., Los Angeles, CA (US)

(72) Inventors: Ian C. Schick, Ojai, CA (US); Orfeas Magoulas, Davis, CA (US); William Wong, Huntington Beach, CA (US); Zakery Tutino, Chittenden, VT (US)

(21) Appl. No.: 19/462,415

(22) Filed: Jan. 28, 2026

Related U.S. Application Data
(63) Continuation-in-part of application No. 18/163,445, filed on Feb. 2, 2023.
Application No. 18/163,445 is a continuation-in-part of application No. 16/901,677, filed on Jun. 15, 2020, now Pat. No. 11,593,564.
Application No. 16/901,677 is a continuation-in-part of application No. 16/739,655, filed on Jan. 10, 2020, now Pat. No. 11,651,160.
Application No. 16/739,655 is a continuation of application No. 16/510,074, filed on Jul. 12, 2019, now Pat. No. 10,572,600.
Application No. 16/510,074 is a continuation of application No. 15/892,679, filed on Feb. 9, 2018, now Pat. No. 10,417,341.
Application No. 16/901,677 is a continuation-in-part of application No. 16/814,335, filed on Mar. 10, 2020, now Pat. No. 11,188,664.
Application No. 16/814,335 is a continuation of application No. 15/936,239, filed on Mar. 26, 2018, now Pat. No. 10,621,371.
Application No. 16/901,677 is a continuation-in-part of application No. 16/025,687, filed on Jul. 2, 2018, now Pat. No. 10,747,953.
Application No. 16/901,677 is a continuation-in-part of application No. 16/025,720, filed on Jul. 2, 2018, now abandoned.
Application No. 18/163,445 is a continuation-in-part of application No. 17/230,548, filed on Apr. 14, 2021, now abandoned.
Application No. 17/230,548 is a continuation-in-part of application No. 16/840,236, filed on Apr. 3, 2020, now Pat. No. 11,023,662.
Application No. 16/840,236 is a continuation of application No. 16/221,070, filed on Dec. 14, 2018, now abandoned.
Application No. 16/221,070 is a continuation-in-part of application No. 15/892,679, filed on Feb. 9, 2018, now Pat. No. 10,417,341.
(63) Continuation-in-part of application No. 18/984,400, filed on Dec. 17, 2024.
(63) Continuation-in-part of application No. 19/186,079, filed on Apr. 22, 2025.
(63) Continuation-in-part of application No. 19/186,174, filed on Apr. 22, 2025.
(63) Continuation-in-part of application No. 19/186,195, filed on Apr. 22, 2025.
Application No. 19/186,195 is a continuation-in-part of application No. 19/065,126, filed on Feb. 27, 2025.
(63) Continuation-in-part of application No. 19/065,107, filed on Feb. 27, 2025.
(63) Continuation-in-part of application No. 19/065,067, filed on Feb. 27, 2025.
(63) Continuation-in-part of application No. 19/083,773, filed on Mar. 19, 2025.
(63) Continuation-in-part of application No. 19/083,830, filed on Mar. 19, 2025.
(63) Continuation-in-part of application No. 19/186,311, filed on Apr. 22, 2025.
(63) Continuation-in-part of application No. 19/015,199, filed on Jan. 9, 2025.
Application No. 19/015,199 is a continuation of application No. 17/230,548, filed on Apr. 14, 2021, now abandoned.
(60) Provisional application No. 62/459,199, filed on Feb. 15, 2017.
(60) Provisional application No. 62/459,208, filed on Feb. 15, 2017.
(60) Provisional application No. 62/459,357, filed on Feb. 15, 2017.
(60) Provisional application No. 62/459,246, filed on Feb. 15, 2017.
(60) Provisional application No. 62/459,235, filed on Feb. 15, 2017.
(60) Provisional application No. 62/479,136, filed on Mar. 30, 2017.
(60) Provisional application No. 62/528,907, filed on Jul. 5, 2017.
(60) Provisional application No. 62/534,793, filed on Jul. 20, 2017.
(60) Provisional application No. 62/539,014, filed on Jul. 31, 2017.
(60) Provisional application No. 62/546,743, filed on Aug. 17, 2017.
(60) Provisional application No. 62/553,096, filed on Aug. 31, 2017.
(60) Provisional application No. 62/561,876, filed on Sep. 22, 2017.
(60) Provisional application No. 62/564,210, filed on Sep. 27, 2017.
(60) Provisional application No. 62/590,274, filed on Nov. 23, 2017.
(60) Provisional application No. 62/599,588, filed on Dec. 15, 2017.
(60) Provisional application No. 62/626,222, filed on Feb. 5, 2018.
(60) Provisional application No. 62/705,315, filed on Jun. 22, 2020.
(60) Provisional application No. 62/705,316, filed on Jun. 22, 2020.
(60) Provisional application No. 62/705,317, filed on Jun. 22, 2020.
(60) Provisional application No. 63/621,217, filed on Jan. 16, 2024.
(60) Provisional application No. 63/560,134, filed on Mar. 1, 2024.
(60) Provisional application No. 63/560,139, filed on Mar. 1, 2024.
(60) Provisional application No. 63/560,124, filed on Mar. 1, 2024.
(60) Provisional application No. 63/560,139, filed on Mar. 1, 2024.
(60) Provisional application No. 63/560,134, filed on Mar. 1, 2024.
(60) Provisional application No. 63/560,124, filed on Mar. 1, 2024.
(60) Provisional application No. 63/560,124, filed on Mar. 1, 2024.
(60) Provisional application No. 63/567,693, filed on Mar. 20, 2024.
(60) Provisional application No. 63/567,708, filed on Mar. 20, 2024.
(60) Provisional application No. 63/567,708, filed on Mar. 20, 2024.
(60) Provisional application No. 63/567,693, filed on Mar. 20, 2024.
(60) Provisional application No. 63/639,991, filed on Apr. 29, 2024.
(60) Provisional application No. 63/639,986, filed on Apr. 29, 2024.
(60) Provisional application No. 63/639,967, filed on Apr. 29, 2024.
(60) Provisional application No. 63/641,170, filed on May 1, 2024.
(60) Provisional application No. 63/751,050, filed on Jan. 29, 2025.
(60) Provisional application No. 63/785,206, filed on Apr. 8, 2025.
(60) Provisional application No. 63/806,339, filed on May 15, 2025.
(60) Provisional application No. 63/875,209, filed on Sep. 3, 2025.
(60) Provisional application No. 63/917,705, filed on Nov. 14, 2025.
(60) Provisional application No. 63/953,127, filed on Jan. 2, 2026.

(51) Int. Cl. G06F 40/30; G06F 40/137; G06F 40/284; G06F 40/56; G06N 20/00; G06Q 10/10; G06Q 50/18

(52) U.S. Cl. CPC G06F 40/30; G06F 40/137; G06F 40/284; G06F 40/56; G06Q 10/10; G06Q 50/184; G06N 20/00

(57) ABSTRACT

Methods, systems, and devices for aligning artificial intelligence-based patent drafting with attorney intent are described. In some examples, the system may receive disclosure materials, which may include documents describing an invention. The system may present multiple versions of generated content, such as different versions of a target for protection, an independent claim, and/or dependent claims, for user selection. Upon receiving a selection of one version, the system may facilitate user editing of the selected content. The edited version may then be incorporated into an auto-generated patent application, ensuring alignment with the attorney's intent. This process may enhance the accuracy and relevance of the patent application by integrating user expertise and feedback into the drafting process.

### CROSS REFERENCE TO RELATED APPLICATIONS

The present Application for Patent claims, either directly or through a parent application, the benefit of:
U.S. patent application Ser. No. 16/510,074 entitled “SYSTEMS AND METHODS FOR USING MACHINE LEARNING AND RULES-BASED ALGORITHMS TO CREATE A PATENT SPECIFICATION BASED ON HUMAN-PROVIDED PATENT CLAIMS SUCH THAT THE PATENT SPECIFICATION IS CREATED WITHOUT HUMAN INTERVENTION” and filed Jul. 12, 2019;
U.S. patent application Ser. No. 16/739,655 entitled “SYSTEMS AND METHODS FOR USING MACHINE LEARNING AND RULES-BASED ALGORITHMS TO CREATE A PATENT SPECIFICATION BASED ON HUMAN-PROVIDED PATENT CLAIMS SUCH THAT THE PATENT SPECIFICATION IS CREATED WITHOUT HUMAN INTERVENTION” and filed Jan. 10, 2020;
U.S. patent application Ser. No. 16/814,335 entitled “SYSTEMS AND METHODS FOR FACILITATING EDITING OF A CONFIDENTIAL DOCUMENT BY A NON-PRIVILEGED PERSON BY STRIPPING AWAY CONTENT AND MEANING FROM THE DOCUMENT WITHOUT HUMAN INTERVENTION SUCH THAT ONLY STRUCTURAL AND/OR GRAMMATICAL INFORMATION OF THE DOCUMENT ARE CONVEYED TO THE NON-PRIVILEGED PERSON” and filed Mar. 10, 2020;
U.S. patent application Ser. No. 16/901,677 entitled “SYSTEMS AND METHODS FOR EXTRACTING PATENT DOCUMENT TEMPLATES FROM A PATENT CORPUS” and filed Jun. 15, 2020;
U.S. patent application Ser. No. 16/840,236 entitled “SYSTEMS AND METHODS FOR PROVIDING ADAPTIVE SURFACE TEXTURE IN AUTO-DRAFTED PATENT DOCUMENTS” and filed Apr. 3, 2020;
U.S. Provisional Patent Application No. 62/705,315 entitled “SYSTEMS AND METHODS FOR DETERMINING WHETHER MULTIPLE INVENTIONS ARE CLAIMED IN A SINGLE PATENT APPLICATION” and filed Jun. 22, 2020;
U.S. Provisional Patent Application No. 62/705,316 entitled “SYSTEMS AND METHODS FOR DETERMINING POTENTIAL SUBJECT MATTER CONFLICTSAMONG PATENT MATTERS” and filed Jun. 22, 2020;
U.S. Provisional Patent Application No. 62/705,317 entitled “SYSTEMS AND METHODS FOR IDENTIFYING AND/OR EXPANDING CLAIM SUPPORT IN APATENT APPLICATION SPECIFICATION” and filed Jun. 22, 2020;
U.S. patent application Ser. No. 17/230,548 entitled “SYSTEMS AND METHODS FOR PROVIDING A DATA STRUCTURE REPRESENTING PATENT CLAIMS” and filed Apr. 14, 2021;
U.S. patent application Ser. No. 18/163,445 entitled “PLATFORM FOR SCALABLE AND EFFICIENT LEGAL DOCUMENT DRAFTING USING GENERATIVE AI AND EXPERT-IN-THE-LOOP” and filed Feb. 2, 2023;
U.S. Provisional Patent Application No. 62/459,199 entitled “SYSTEMS AND METHODS FOR PROVIDING A DATA STRUCTURE REPRESENTING PATENT CLAIMS” and filed Feb. 15, 2017;
U.S. Provisional Patent Application No. 62/459,208 entitled “SYSTEMS AND METHODS FOR MODIFYING DATA STRUCTURES REPRESENTING PATENT CLAIMS SUCH THAT THE MODIFIED DATA STRUCTURES INCLUDE LANGUAGE ELEMENTS IN PROSE RATHER THAN PATENTESE” and filed Feb. 15, 2017;
U.S. Provisional Patent Application No. 62/459,357 entitled “SYSTEMS AND METHODS FOR USING MACHINE LEARNING AND RULES-BASED ALGORITHMS TO CREATE A PATENT SPECIFICATION BASED ON HUMAN-PROVIDED PATENT CLAIMS SUCH THAT THE PATENT SPECIFICATION IS CREATED WITHOUT HUMAN INTERVENTION” and filed Feb. 15, 2017;
U.S. Provisional Patent Application No. 62/459,246 entitled “SYSTEMS AND METHODS FOR IDENTIFYING AND NAMING SOFTWARE COMPONENTS DESCRIBED BY FUNCTIONAL PATENT CLAIM LANGUAGE” and filed Feb. 15, 2017;
U.S. Provisional Patent Application No. 62/459,235 entitled “SYSTEMS AND METHODS FOR PROVIDING A DATA STRUCTURE WITH ORDERED CONTENT DERIVED FROM PATENT CLAIMS” and filed Feb. 15, 2017;
U.S. Provisional Patent Application No. 62/479,136 entitled “SYSTEMS AND METHODS FOR FACILITATING REVIEW OF A CONFIDENTIAL DOCUMENT BY A NON-PRIVILEGED PERSON BY STRIPPING AWAY CONTENT AND MEANING FROM THE DOCUMENT WITHOUT HUMAN INTERVENTION SUCH THAT ONLY STRUCTURAL AND/OR GRAMMATICAL INFORMATION OF THE DOCUMENT ARE CONVEYED TO THE NON-PRIVILEGED PERSON” and filed Mar. 30, 2017;
U.S. Provisional Patent Application No. 62/515,096 entitled “SYSTEMS AND METHODS FOR PROVIDING AN AUTOMATED INTELLECTUAL PROPERTY AUCTION PLATFORM CONFIGURED TO USE AN AUTOMATED NATURAL LANGUAGE GENERATION SYSTEM TO GENERATE DRAFT PATENT APPLICATIONS BASED ON CROWDSOURCED DRAFT PATENT CLAIMS, ESTABLISH PRIORITY DATES BY BLOCKCHAIN RECORDATION AS OPPOSED TO PATENT OFFICE FILING, AND DEDICATE TO THE PUBLIC ANY INTELLECTUAL PROPERTY THAT IS NOT SUCCESSFULLY AUCTIONED” and filed Jun. 5, 2017;
U.S. Provisional Patent Application No. 62/516,640 entitled “SYSTEMS AND METHODS FOR PROVIDING AN INTERACTIVE INTERFACE THAT ELICITS INVENTION DISCLOSURES FROM INVENTORS IN ORDER TO PRODUCE STANDARDIZED INVENTION DISCLOSURE DOCUMENTS” and filed Jun. 7, 2017;
U.S. Provisional Patent Application No. 62/519,852 entitled “SYSTEMS AND METHODS FOR CONVERTING SHORT PLAIN-LANGUAGE FEATURE SUMMARIES INTO CLAIM LANGUAGE USING A NATURAL LANGUAGE GENERATION SYSTEM TRAINED ON PLAIN-LANGUAGE FEATURE SUMMARIES EXTRACTED FROM PATENT LITERATURE” and filed Jun. 14, 2017;
U.S. Provisional Patent Application No. 62/519,850 entitled “SYSTEMS AND METHODS FOR GENERATING, AUTOMATICALLY AND WITHOUT HUMAN INTERVENTION, A BRIEF SECTION OF A PATENT APPLICATION BASED ON INPUT CLAIM LANGUAGE” and filed Jun. 14, 2017;
U.S. Provisional Patent Application No. 62/519,847 entitled “SYSTEMS AND METHODS FOR MONITORING INFORMATION FLOW OF AN ORGANIZATION TO IDENTIFY POTENTIAL TOPICS FOR PATENT PROTECTION” and filed Jun. 14, 2017;
U.S. Provisional Patent Application No. 62/523,257 entitled “SYSTEMS AND METHODS FOR OBTAINING AT ALIGNMENT BETWEEN INDIVIDUAL FEATURES OF PATENT CLAIMS AND CORRESPONDING DESCRIPTIONS IN A SPECIFICATION OF THE SAME PATENT DOCUMENT” and filed Jun. 22, 2017;
U.S. Provisional Patent Application No. 62/523,258 entitled “SYSTEMS AND METHODS FOR SIMULATING A HUMAN-PATENT-EXAMINER-PERFORMED PATENTABILITY SEARCH BASED ON ONE OR MORE CLAIM SETS ASSOCIATED WITH A SUBJECT PATENT APPLICATION, THE SIMULATION LEVERAGING HISTORICAL HUMAN-PATENT-EXAMINER-PRODUCED PATENTABILITY SEARCH STRATEGY REPORTS” and filed Jun. 22, 2017;
U.S. Provisional Patent Application No. 62/523,260 entitled “SYSTEMS AND METHODS FOR USING PATENT DOCUMENT FACTORING TO IDENTIFY COMBINABLE FACTOR PATENT DOCUMENTS AND A CORRESPONDING PRODUCT PATENT DOCUMENT” and filed Jun. 22, 2017;
U.S. Provisional Patent Application No. 62/523,262 entitled “SYSTEMS AND METHODS FOR SIMULATING A HUMAN-PATENT-EXAMINER-PERFORMED PATENTABILITY SEARCH BASED ON ONE OR MORE CLAIM SETS ASSOCIATED WITH A SUBJECT PATENT APPLICATION, THE SIMULATION LEVERAGING HISTORICAL HUMAN-PATENT-EXAMINER-PRODUCED OFFICE ACTION CITATIONS” and filed Jun. 22, 2017;
U.S. Provisional Patent Application No. 62/528,907 entitled “SYSTEMS AND METHODS FOR INDUCING PATENT APPLICATION TEMPLATES FROM PATENT CORPORA” and filed Jul. 5, 2017;
U.S. Provisional Patent Application No. 62/526,316 entitled “SYSTEMS AND METHODS FOR ENHANCING THE DEPTH AND RICHNESS OF CONTENT IN COMPUTER-GENERATED PATENT APPLICATIONS BY PROVIDING NON-EXPLICIT SUPPORT FOR INDIVIDUAL CLAIM FEATURES” and filed Jun. 28, 2017;
U.S. Provisional Patent Application No. 62/526,314 entitled “SYSTEMS AND METHODS FOR PREDICTING PATENT CLASSIFICATIONS ASSOCIATED WITH PATENT CLAIMS BASED ON A HIERARCHICAL MACHINE LEARNING CLASSIFIER” and filed Jun. 28, 2017;
U.S. Provisional Patent Application No. 62/534,793 entitled “SYSTEMS AND METHODS FOR PROVIDING DISTINCT VARIATIONS OF PATENT CLAIMS” and filed Jul. 20, 2017;
U.S. Provisional Patent Application No. 62/539,014 entitled “SYSTEMS AND METHODS FOR ENCODING PATENT CLAIMS IN A FORMAT THAT IS BOTH HUMAN-READABLE AND MACHINE-READABLE” and filed Jul. 31, 2017;
U.S. Provisional Patent Application No. 62/546,743 entitled “SYSTEMS AND METHODS FOR IDENTIFYING FEATURES IN PATENT CLAIMS THAT EXIST IN THE PRIOR ART” and filed Aug. 17, 2017;
U.S. Provisional Patent Application No. 62/553,096 entitled “SYSTEMS AND METHODS FOR PREDICTING, WITH NO HUMAN INTERVENTION, AN OFFICE ACTION REJECTION NARRATIVE AND CORRESPONDING PRIOR ART CITATION FOR INDIVIDUAL CLAIM FEATURES” and filed Aug. 31, 2017;
U.S. Provisional Patent Application No. 62/561,876 entitled “SYSTEMS AND METHODS FOR AUTOMATICALLY CREATING A PATENT APPLICATION BASED ON A CLAIM SET SUCH THAT THE PATENT APPLICATION FOLLOWS A DOCUMENT PLAN INFERRED FROM AN EXAMPLE DOCUMENT” and filed Sep. 22, 2017;
U.S. Provisional Patent Application No. 62/564,210 entitled “SYSTEMS AND METHODS FOR SUPPLEMENTING CONTENT IN A COMPUTER-GENERATED PATENT APPLICATION BY IDENTIFYING AND EXPANDING ON KEY WORDS AND PHRASES USING NATURAL LANGUAGE GENERATION” and filed Sep. 27, 2017;
U.S. Provisional Patent Application No. 62/590,274 entitled “SYSTEMS AND METHODS FOR FACILITATING EDITING OF A CONFIDENTIAL DOCUMENT BY A NON-PRIVILEGED PERSON BY STRIPPING AWAY CONTENT AND MEANING FROM THE DOCUMENT WITHOUT HUMAN INTERVENTION SUCH THAT ONLY STRUCTURAL AND/OR GRAMMATICAL INFORMATION OF THE DOCUMENT ARE CONVEYED TO THE NON-PRIVILEGED PERSON” and filed Nov. 23, 2017;
U.S. Provisional Patent Application No. 62/599,588 entitled “SYSTEMS AND METHODS FOR GENERATING, BASED ON ONE OR MORE SETS OF PATENT CLAIMS, WITHOUT HUMAN INTERVENTION, AN OFFICIAL PATENT OFFICE SUBMISSION OF RELEVANT BACKGROUND OR INFORMATION” and filed Dec. 15, 2017;
U.S. patent application Ser. No. 15/892,679 entitled “SYSTEMS AND METHODS FOR USING MACHINE LEARNING AND RULES-BASED ALGORITHMS TO CREATE A PATENT SPECIFICATION BASED ON HUMAN-PROVIDED PATENT CLAIMS SUCH THAT THE PATENT SPECIFICATION IS CREATED WITHOUT HUMAN INTERVENTION” and filed Feb. 9, 2018;
U.S. Provisional Patent Application No. 62/626,222 entitled “SYSTEMS AND METHODS FOR PROVIDING ADAPTIVE SURFACE TEXTURE IN AUTO-DRAFTED PATENT DOCUMENTS” and filed Feb. 5, 2018;
U.S. patent application Ser. No. 15/936,239 entitled “SYSTEMS AND METHODS FOR FACILITATING EDITING OF A CONFIDENTIAL DOCUMENT BY A NON-PRIVILEGED PERSON BY STRIPPING AWAY CONTENT AND MEANING FROM THE DOCUMENT WITHOUT HUMAN INTERVENTION SUCH THAT ONLY STRUCTURAL AND/OR GRAMMATICAL INFORMATION OF THE DOCUMENT ARE CONVEYED TO THE NON-PRIVILEGED PERSON” and filed Mar. 26, 2018;
U.S. patent application Ser. No. 15/994,756 entitled “MACHINE LEARNING MODEL FOR COMPUTER-GENERATED PATENT APPLICATIONS TO PROVIDE SUPPORT FOR INDIVIDUAL CLAIM FEATURES IN A SPECIFICATION” and filed May 31, 2018; °U.S. patent application Ser. No. 16/025,687 entitled “SYSTEMS AND METHODS FOR AUTOMATICALLY CREATING A PATENT APPLICATION BASED ON A CLAIM SET SUCH THAT THE PATENT APPLICATION FOLLOWS A DOCUMENT PLAN INFERRED FROM AN EXAMPLE DOCUMENT” and filed Jul. 2, 2018;
U.S. patent application Ser. No. 16/025,720 entitled “SYSTEMS AND METHODS FOR IDENTIFYING FEATURES IN PATENT CLAIMS THAT EXIST IN THE PRIOR ART” and filed Jul. 2, 2018;
U.S. patent application Ser. No. 16/221,070 entitled “SYSTEMS AND METHODS FOR GENERATING, BASED ON ONE OR MORE SETS OF PATENT CLAIMS, WITHOUT HUMAN INTERVENTION, AN OFFICIAL PATENT OFFICE SUBMISSION OF RELEVANT BACKGROUND OR INFORMATION” and filed Dec. 14, 2018;
U.S. Provisional Patent Application No. 63/621,217entitled “AUTO-DRAFTING A PATENT DOCUMENT BIASED TOWARD A TARGET FOR PROTECTION” and filed Jan. 16, 2024;
U.S. Provisional Patent Application No. 63/560,134 entitled “AUTOMATING GENERATION OF PATENT APPLICATION FIGURES FROM CLAIM INFORMATION” and filed Mar. 1, 2024;
U.S. Provisional Patent Application No. 63/560,139 entitled “INTERACTIVE POST-EDITING OF AUTOMATED PATENT DRAWINGS” and filed Mar. 1, 2024;
U.S. Provisional Patent Application No. 63/560,124 entitled “GENERATING AUTOMATED PATENT DRAWINGS FROM DESCRIPTIVE CODE” and filed Mar. 1, 2024;
U.S. Provisional Patent Application No. 63/567,693 entitled “CAPTURING AND FLATTENING DOCUMENT VISUAL CONTENT FOR PATENT APPLICATIONS” and filed Mar. 20, 2024
U.S. Provisional Patent Application No. 63/567,708 entitled “AUTO-GENERATING FORMAL PATENT DRAWINGS FROM INVENTOR DISCLOSURES” and filed Mar. 20, 2024;
U.S. Provisional Patent Application No. 63/639,967 entitled “REGENERATING PATENT APPLICATIONS WITH SPECIFICATION ALTERATIONS AND FIGURE MANAGEMENT” and filed Apr. 29, 2024
U.S. Provisional Patent Application No. 63639,986 entitled “EVALUATING INVENTION DISCLOSURES TO IDENTIFY AND FILL INFORMATION VOIDS” and filed Apr. 29, 2024;
U.S. Provisional Patent Application No. 63/641,170 entitled “AUTOMATING PRIOR ART ANALYSIS FOR INVENTION DISCLOSURE REFINEMENT” and filed May 1, 2024;
U.S. Provisional Patent Application No. 63/639,991entitled “PRIORITY-BASED ROUTING OF PATENT DOCUMENTATION TASKS” and filed Apr. 29, 2024;
U.S. patent application Ser. No. 18/984,400 entitled “AUTOMATING THE DRAFTING OF PATENT DOCUMENTS WITH GENERATIVE AI AND EXPERT FEEDBACK” and filed Dec. 17, 2024;
U.S. patent application Ser. No. 19/186,079 entitled “PRIORITY-BASED ROUTING OF PATENT DOCUMENTATION TASKS” and filed Apr. 22, 2025;
U.S. patent application Ser. No. 19/186,174 entitled “AUTOMATING PRIOR ART ANALYSIS FOR INVENTION DISCLOSURE REFINEMENT” and filed Apr. 22, 2025;
U.S. patent application Ser. No. 19/186,195 entitled “EVALUATING INVENTION DISCLOSURES TO IDENTIFY AND FILL INFORMATION VOIDS” and filed Apr. 22, 2025;
U.S. patent application Ser. No. 19/015,199 entitled “SYSTEMS AND METHODS FOR DETERMINING POTENTIAL SUBJECT MATTER CONFLICTS AMONG PATENT MATTERS” and filed Jan. 9, 2024;
U.S. patent application Ser. No. 19/065,126 entitled “AUTOMATING GENERATION OF PATENT APPLICATION FIGURES FROM CLAIM INFORMATION” and filed Feb. 27, 2024;
U.S. patent application Ser. No. 19/065,107 entitled “INTERACTIVE POST-EDITING OF AUTOMATED PATENT DRAWINGS” and filed Feb. 27, 2024;
U.S. patent application Ser. No. 19/065,067 entitled “GENERATING AUTOMATED PATENT DRAWINGS FROM DESCRIPTIVE CODE” and filed Feb. 27, 2024;
U.S. patent application Ser. No. 19/083,773 entitled “CAPTURING AND FLATTENING DOCUMENT VISUAL CONTENT FOR PATENT APPLICATIONS” and filed Mar. 19, 2024;
U.S. patent application Ser. No. 19/083,830 entitled “CAPTURING AND FLATTENING DOCUMENT VISUAL CONTENT FOR PATENT APPLICATIONS” and filed Mar. 19, 2024;
U.S. patent application Ser. No. 19/186,311entitled “REGENERATING PATENT APPLICATIONS WITH SPECIFICATION ALTERATIONS AND FIGURE MANAGEMENT and filed Apr. 22, 2024;
U.S. Provisional Patent Application No. 63/751,050 entitled “AUTOMATING PATENT APPLICATION DRAFTING WITH ITERATIVE PRIOR ART ANALYSIS” and filed Jan. 29, 2025;
U.S. Provisional Patent Application No. 63/785,209 entitled “GENERATING INVENTION DISCLOSURES BASED ON INVENTION TITLES” and filed Apr. 8, 2025;
U.S. Provisional Patent Application No. 63/785,206 entitled “ALIGNING PATENT PORTFOLIOS WITH MARKETING STRATEGIES” and filed Apr. 8, 2025
U.S. Provisional Patent Application No. 63/806,339 entitled “ALIGNING AUTO-GENERATED PATENT APPLICATION CONTENT WITH ATTORNEY INTENT” and filed May 15, 2025;
U.S. Provisional Patent Application No. 63/917,705 entitled “SIMULATING LEGAL DOCUMENT REVIEW AND TRAINING” and filed Nov. 14, 2025; and
U.S. Provisional Patent Application No. 63/953,127 entitled “GENERATING PATENT APPLICATION DOCUMENTS FROM SOFTWARE CODE REPOSITORIESWITH PROVENANCE LINKS” and filed Jan. 2, 2026; which are assigned to the assignee hereof, and are hereby incorporated by reference in their entirety.

### FIELD OF TECHNOLOGY

The present disclosure relates generally to database systems and data processing, and more specifically to auto-generating formal patent drawings from inventor disclosures.

### BACKGROUND

In recent years, the field of artificial intelligence has seen significant advancements, particularly in automating complex tasks traditionally performed by humans. Patent drafting, a meticulous and detail-oriented process, has been a focus for automation due to its complexity and the expertise required. Existing systems may assist in drafting patent applications by providing templates or suggesting language based on input data.

### SUMMARY

The described techniques relate to improved methods, systems, devices, and apparatuses that support techniques for aligning auto-generated patent content with attorney intent. Some implementations introduce an agentic artificial intelligence system designed to draft complete patent applications by aligning closely with attorney users through a structured process. This system may incorporate an innovative “eye test” feature, presenting users with multiple content options and requiring them to select the most suitable version before proceeding. This may ensure that users actively engage with the content, leveraging their expertise to guide the drafting process. By doing so, the system may align the final application with the strategic protection goals.

Additionally, some implementations may include a change threshold mechanism to further enhance user engagement. By measuring the extent of user modifications, the system may ensure that users have thoroughly reviewed and processed the content, fostering deeper alignment between the user and the system. Furthermore, the system may allow for content regeneration based on specific user instructions, enabling users to refine the application to better meet their needs. A clean-up function may also be integrated to automatically correct issues related to 35 U.S.C. § 112 (Section 112) and other drafting conventions, streamlining the process and reducing the need for external proofreading services. Together, these features may create a comprehensive solution that enhances the efficiency and effectiveness of patent application drafting.

A method for aligning AI-based patent drafting with attorney intent is described. The method may include receiving invention disclosure materials, the invention disclosure materials including one or more documents that describe an invention. The method may include presenting multiple versions of generated content for selection, the multiple versions of generated content including different versions of one or more of a target for protection, an independent claim, and/or one or more dependent claims. The method may include, in response to receiving a selection of one version of the generated content, facilitating user editing of the selected version of the generated content. The method may include incorporating an edited copy of the selected version of the generated content into an auto-generated patent application.

A system configured for aligning AI-based patent drafting with attorney intent is described. The system may include a processor and memory coupled with the processor. The system may include instructions stored in the memory and executable by the processor to cause the system to receive invention disclosure materials, where the invention disclosure materials may include one or more documents that describe an invention. The system may present multiple versions of generated content for selection, where the multiple versions of generated content may include different versions of one or more of a target for protection, an independent claim, and/or one or more dependent claims. The system may facilitate user editing of the selected version of the generated content in response to receiving a selection of one version of the generated content. The system may incorporate an edited copy of the selected version of the generated content into an auto-generated patent application.

Another system for aligning AI-based patent drafting with attorney intent is described. The system may include means for receiving invention disclosure materials, the invention disclosure materials including one or more documents that describe an invention. The system may include means for presenting multiple versions of generated content for selection, the multiple versions of generated content including different versions of one or more of a target for protection, an independent claim, and/or one or more dependent claims. The system may include means for facilitating user editing of the selected version of the generated content in response to receiving a selection of one version of the generated content. The system may include means for incorporating an edited copy of the selected version of the generated content into an auto-generated patent application.

A non-transitory computer-readable medium storing code for aligning AI-based patent drafting with attorney intent is described. The code may include instructions executable by a processor to receive invention disclosure materials, the invention disclosure materials including one or more documents that may describe an invention. The code may include instructions executable by a processor to present multiple versions of generated content for selection, the multiple versions of generated content including different versions of one or more of a target for protection, an independent claim, and/or one or more dependent claims. The code may include instructions executable by a processor to facilitate user editing of the selected version of the generated content in response to receiving a selection of one version of the generated content. The code may include instructions executable by a processor to incorporate an edited copy of the selected version of the generated content into an auto-generated patent application.

Some examples of the method, systems, and non-transitory computer-readable medium described herein may further include operations, features, means, or instructions for receiving user feedback on the selected version of the generated content. The presentation of subsequent versions of generated content may be adjusted based on the user feedback to enhance alignment with attorney intent.

Some examples of the method, systems, and non-transitory computer-readable medium described herein may further include operations, features, means, or instructions for storing a history of user edits to the selected version of the generated content in a database. The history may be accessible for reuse.

Some examples of the method, systems, and non-transitory computer-readable medium described herein may further include operations, features, means, or instructions for determining a threshold amount of changes made by the user to the selected independent claim. The changes may indicate user engagement with the content.

Some examples of the method, systems, and non-transitory computer-readable medium described herein may further include operations, features, means, or instructions for providing a notification to the user in response to detecting that the user has not made a threshold amount of changes to the selected version of the generated content.

Some examples of the method, systems, and non-transitory computer-readable medium described herein may further include operations, features, means, or instructions for enabling the user to input specific instructions for regenerating the selected version of the generated content. The regenerated content may be accessible with previous versions for comparison and selection.

Some examples of the method, systems, and non-transitory computer-readable medium described herein may further include operations, features, means, or instructions for automatically correcting errors in the selected version of the generated content. The errors may be related to one or both of drafting requirements or conventions.

In some examples of the method, systems, and non-transitory computer-readable medium described herein, the invention disclosure materials may include multimedia files that provide visual context for the invention.

In some examples of the method, systems, and non-transitory computer-readable medium described herein, the user editing interface may include tools for annotating the selected version of the generated content.

In some examples of the method, systems, and non-transitory computer-readable medium described herein, the presentation of multiple versions of generated content may include a scoring system that ranks the versions based on alignment with user preferences.

In some examples of the method, systems, and non-transitory computer-readable medium described herein, the auto-generated patent application may include a summary section that highlights key features of the invention disclosure materials.

### BRIEF DESCRIPTION OF THE DRAWINGS

FIG. 1 illustrates an example of a system for data processing that supports aligning auto-generated patent content with attorney intent in accordance with aspects of the present disclosure.

FIG. 2 shows user interface which supports techniques for aligning auto-generated patent content with attorney intent in accordance with various aspects of the present disclosure.

FIG. 3 shows user interface which supports techniques for aligning auto-generated patent content with attorney intent in accordance with various aspects of the present disclosure.

FIG. 4 shows user interface which supports techniques for aligning auto-generated patent content with attorney intent in accordance with various aspects of the present disclosure.

FIG. 5 shows user interface which supports techniques for aligning auto-generated patent content with attorney intent in accordance with various aspects of the present disclosure.

FIG. 6 shows user interface which supports techniques for aligning auto-generated patent content with attorney intent in accordance with various aspects of the present disclosure.

FIG. 7 illustrates an example of a process flow that supports aligning auto-generated patent content with attorney intent in accordance with various aspects of the present disclosure.

FIG. 8 shows a block diagram of an apparatus that supports aligning auto-generated patent content with attorney intent in accordance with various aspects of the present disclosure.

FIG. 9 shows a block diagram of an AI-based patent alignment component that supports aligning auto-generated patent content with attorney intent in accordance with various aspects of the present disclosure.

FIG. 10 shows a diagram of a system including a device that supports aligning auto-generated patent content with attorney intent in accordance with various aspects of the present disclosure.

FIGS. 11 and 12 show flowcharts illustrating methods that support aligning auto-generated patent content with attorney intent in accordance with various aspects of the present disclosure.

### DETAILED DESCRIPTION

Methods, systems, devices, and apparatuses that support techniques for aligning auto-generated patent content with attorney intent are disclosed. In some examples, despite advancements in artificial intelligence, current systems for drafting patent applications may fall short in achieving full automation and alignment with the strategic goals of inventors and attorneys. These systems may often produce generic outputs that require significant manual editing to tailor the application to the specific invention and legal requirements. Additionally, existing tools may not effectively engage users in the drafting process, leading to potential misalignment between the drafted application and the inventor's intent. This misalignment may result in inadequate protection of the invention, increased legal risks, and additional costs for revisions and legal consultations.

According to some implementations, an artificial intelligence system may be designed to draft complete patent applications by working closely with attorney users through a structured process. This system may ensure that the final document aligns with the intended protection strategy. The process may involve aligning on critical parts of the patent application, such as the target for protection, independent claims, dependent claims, and figures.

To enhance user engagement, the system may include an “eye test” for content selection. This feature may present users with two versions of a piece of content, such as an independent claim, and require them to choose the version that offers better protection for the invention before they may edit and proceed. This approach may prevent users from simply clicking through without providing valuable input.

The system may measure the amount of changes a user makes to the text. If a user modifies a threshold amount of text, it may indicate that they have mentally processed the content, which may facilitate further alignment between the user and the system. In some implementations, users may be prevented from proceeding unless they reach this threshold. Alternatively, if the threshold is not met, a message may prompt the user to confirm their decision to proceed.

The system may allow users to regenerate content by providing specific instructions for revision. This feature may not function as a prompt or chat interface but may require users to give detailed directions for content regeneration. Users may have the option to revert to previous versions after regeneration.

The system may include a clean-up function that corrects basic errors related to Section 112 and other drafting conventions required by patent offices. This function may automate the proofreading process, addressing common errors and ensuring compliance with regulatory standards. By integrating these features, some implementations may streamline the patent drafting process and enhance user engagement.

Aspects of the subject matter described in this disclosure can be implemented to realize one or more of the following potential advantages. The described techniques may be implemented to support a more efficient and user-focused patent drafting process by encouraging active participation from attorney users. The system may foster a deeper understanding of the invention and its strategic protection by requiring users to engage with content through selection and editing tasks. By incorporating features that may prompt users to reflect on their choices, the system may enhance the quality of the final patent application. The ability to regenerate content based on specific instructions may empower users to tailor the document to better meet their objectives. Furthermore, the clean-up function may ensure compliance with drafting standards, potentially reducing the need for external proofreading services. Overall, these implementations may streamline the patent application process, making it more accessible and effective for users.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to aligning auto-generated patent content with attorney intent.

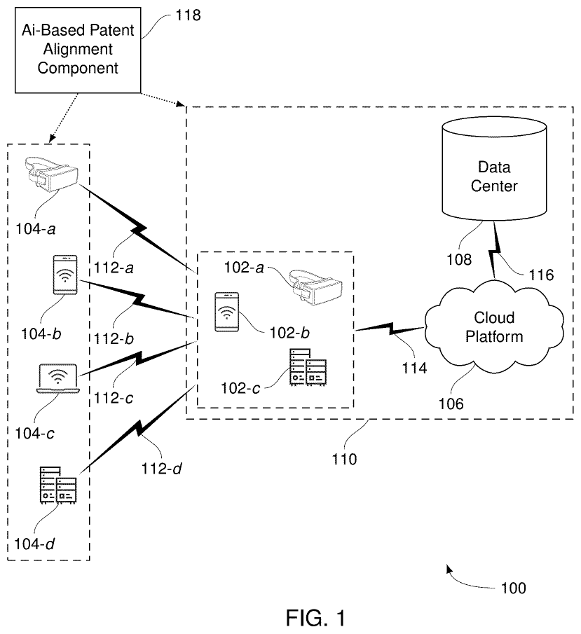

FIG. 1 illustrates an example of a system 100 that supports aligning auto-generated patent content with attorney intent in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a non-profit, a startup, or any other organization type.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include an AI-based patent alignment component 118. The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be computing device such as a wearable device 104-a, a smartphone 104-b, a laptop 104-c or a server 104-d. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including—but not limited to—client-server systems, mobile device systems, and mobile network systems. In some cases, cloud platform 106 may support an online application. This may include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, an AI-based patent alignment component 118, and a data center 108 that may coordinate with cloud platform 106 and data center 108 to implement an online environment. In some cases, data processing may occur at any of the components of server system 110, or at a combination of these components. Thus, the AI-based patent alignment component 118 may be included in the user device 104, server system 110, or in part or in whole in both. In some cases, servers may perform the data processing. The servers may be a cloud client 102 or located at data center 108.

Some or all of the functionality attributed to the AI-based patent alignment component 118 may be embodied or performed by one or more user devices 104, one or more components of server system 110 (e.g., cloud clients 102, a cloud platform 106, and/or a data center 108), and/or other components of system 100. The AI-based patent alignment component 118 may receive signals and inputs from user device 104 directly. via cloud clients 102, and/or via cloud platform 106 or data center 116.

As described herein, some implementations may utilize the AI-based patent alignment component 118 to facilitate the drafting of patent applications by receiving invention disclosure materials from user devices 110. The AI-based patent alignment component 118 may present multiple versions of generated content, such as independent claims and dependent claims, to the user device 110 for selection. Upon receiving a selection, the AI-based patent alignment component 118 may enable user editing of the chosen version, allowing for alignment with attorney intent. The edited content may then be incorporated into an auto-generated patent application, which may be stored and processed within the cloud platform 106 or data center 108. The AI-based patent alignment component 118 may operate across various network connections, including those between cloud clients 102 and user devices 110, ensuring seamless integration and communication within the system 100.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

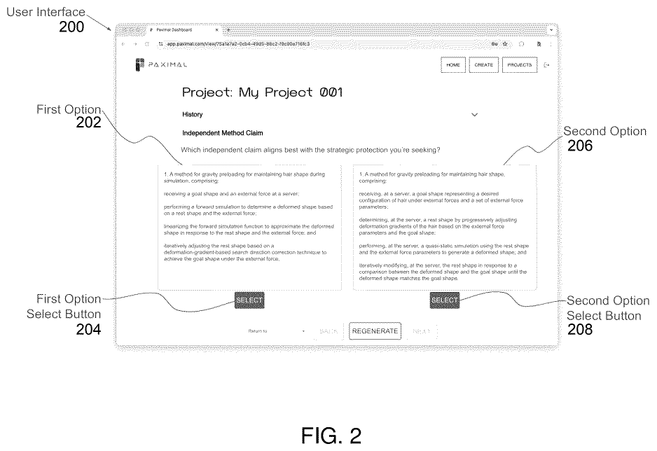

FIG. 2 shows user interface 200 which supports techniques for aligning auto-generated patent content with attorney intent in accordance with various aspects of the present disclosure. The user interface 200 may include interactive elements for aligning patent drafts with attorney input. The user interface 200 may be designed to facilitate the alignment process by presenting options and fields for user interaction. It may include visual displays and buttons that guide the user through the alignment steps. The user interface 200 may be customizable to accommodate different user preferences and project requirements. As depicted in FIG. 2, the user interface 200 may include one or more of a first option 202, a first option select button 204, a second option 206, a second option select button 208, and/or other components.

The first option 202 may represent a selectable choice displayed within the user interface 200. The first option 202 may be presented to the user as part of a decision-making process within the system. It may be designed to guide the user through selecting specific content or actions related to patent drafting. In some implementations, the first option 202 may be visually distinct to ensure clarity and ease of selection. The first option 202 may be one of several choices available to the user, allowing for tailored interactions based on user input.

The first option select button 204 may include an interactive element for selecting the first option 202 within the user interface 200. The first option select button 204 may be a clickable element that allows the user to confirm their choice of the first option 202. It may be designed to provide immediate feedback upon selection, such as highlighting or changing color. In some implementations, the first option select button 204 may be positioned adjacent to the first option 202 to maintain a logical flow in the user interface. The button may be configured to trigger specific actions or transitions within the system once selected.

The second option 206 may represent an alternative selectable choice displayed within the user interface 200. The second option 206 may offer a different path or set of actions compared to the first option 202, catering to diverse user needs or preferences. It may be presented alongside the first option 202 to provide a comprehensive range of choices. In some implementations, the second option 206 may be designed to contrast visually with the first option 202, ensuring users can easily differentiate between the available selections. The second option 206 may be part of a broader decision-making framework within the system.

The second option select button 208 may include an interactive element for selecting the second option 206 within the user interface 200. The second option select button 208 may function similarly to the first option select button 204, allowing users to confirm their choice of the second option 206. It may provide visual or auditory feedback to indicate successful selection. In some implementations, the second option select button 208 may be strategically placed to align with the second option 206, facilitating a seamless user experience. The button may initiate specific processes or changes within the system upon activation.

In some implementations, the user interface 200 may present a first option 202 and a second option 206 side by side, allowing the user to visually compare the two independent claims. The first option select button 204 may be positioned directly below the first option 202, while the second option select button 208 may be located beneath the second option 206. This arrangement may facilitate the “eye test” process by enabling the user to easily select the preferred claim version. Once a selection is made, the system may prompt the user to engage further with the content, potentially by editing the chosen claim to align it more closely with the strategic goals of the project. The interface may also include additional controls, such as buttons for content regeneration and clean-up, which may be used to refine the text based on user input and predefined drafting conventions. In some implementations, when a given content option is selected, a third option may appear by replacing the unselected content option. The user may be required to selected between the second pair of content options before proceeding to editing.

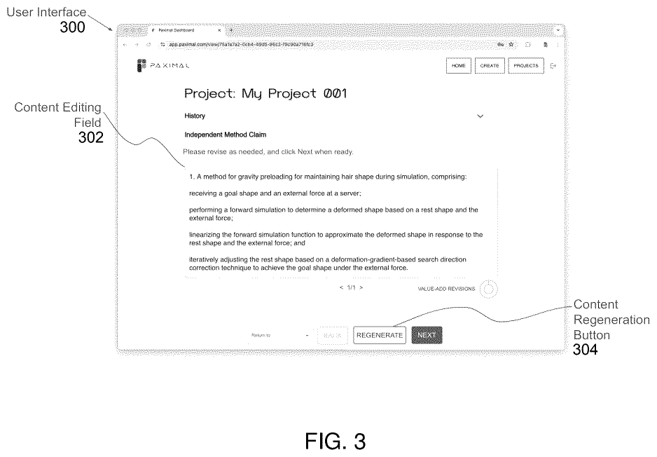

FIG. 3 shows user interface 300 which supports techniques for aligning auto-generated patent content with attorney intent in accordance with various aspects of the present disclosure. As depicted in FIG. 3, the user interface 300 may include one or more of a content editing field 302, a content regeneration button 304, and/or other components.

The content editing field 302 may represent a designated area for users to modify text during the alignment process. The content editing field 302 may be a text box or similar interface where users can input changes to the patent draft. It may allow users to make revisions to specific sections of the document, such as claims or descriptions. The content editing field 302 may support various text formatting options to ensure clarity and precision in the document.

The content regeneration button 304 may provide functionality for regenerating content based on user-provided instructions. The content regeneration button 304 may be an interactive element that users can click to initiate the regeneration process. It may work in conjunction with the regeneration instructions field 308, where users input specific directions for content revision. In some implementations, the content regeneration button 304 may allow users to revert to previous versions of the content if needed. The content regeneration button 304 may be designed to ensure that the regenerated content aligns with the user's strategic goals.

In some implementations, the user interface 302 may serve as the primary platform through which users interact with the system, displaying various components such as the content editing field 302 and the content regeneration button 304. The content editing field 302 may allow users to make modifications to the text, ensuring that the content aligns with their expertise and strategic goals. The content regeneration button 304 may be used to request revised content.

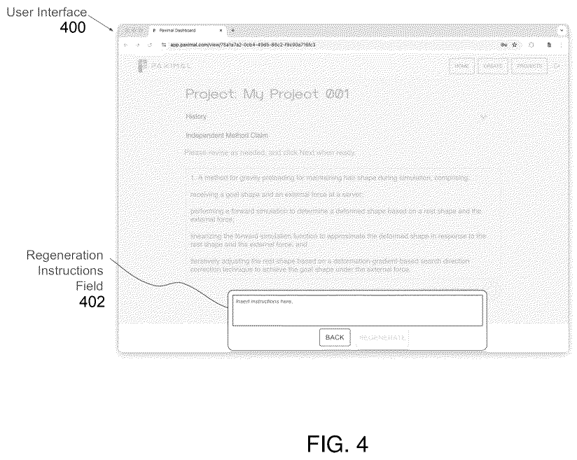

FIG. 4 shows user interface 400 which supports techniques for aligning auto-generated patent content with attorney intent in accordance with various aspects of the present disclosure. The user interface 400 may include interactive elements for aligning patent drafts with attorney input. In some implementations, the user interface 500 may be the same as or similar to the user interface 200 and/or the user interface 300, as described herein. As depicted in FIG. 4, the user interface 400 may include a regeneration instructions field 402 and/or other components.

The regeneration instructions field 402 may include a space for users to input specific directions for content revision. The regeneration instructions field 402 may be a text entry area where users can specify the changes they want to see in the regenerated content. It may support detailed instructions to guide the system in producing the desired output. In some implementations, the regeneration instructions field 402 may be linked to the content regeneration button 304 to execute the user's directions. The regeneration instructions field 402 may accommodate various types of input, such as keywords or phrases, to tailor the content to specific needs.

In some implementations, the user interface 400 may serve as the central interface through which users interact with the system. The regeneration instructions field 402 may be used by users to input specific directions for content regeneration, ensuring that the system's output aligns with their expertise.

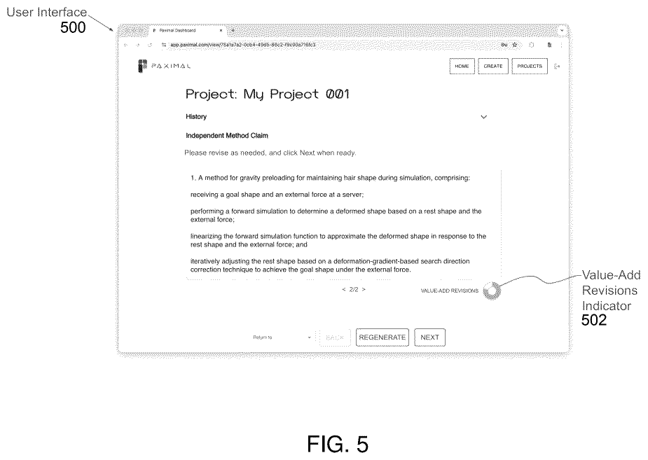

FIG. 5 shows user interface 500 which supports techniques for aligning auto-generated patent content with attorney intent in accordance with various aspects of the present disclosure. The user interface 500 may include interactive elements for aligning patent drafts with attorney input. In some implementations, the user interface 500 may be the same as or similar to the user interface 200, the user interface 300, and/or the user interface 400, as described herein. As depicted in FIG. 5, the user interface 500 may include a value-add revisions indicator 502 and/or other components.

The value-add revisions indicator 502 may provide a visual cue for tracking changes made to the text during the alignment process. The value-add revisions indicator 502 may represent a visual display of the changes made to the text during the alignment process. The value-add revisions indicator 502 may be a graphical element that shows the extent of modifications made by the user. It may help users track their progress and ensure that they have sufficiently processed the content. In some implementations, the value-add revisions indicator 502 may be connected to the content editing field 302 to update in real-time as changes are made. The value-add revisions indicator 502 may include features such as color coding or percentage bars to visually represent the amount of text altered.

In some implementations, the user interface 500 may serve as the primary platform through which users interact with the AI system, allowing them to view and select content options. The value-add revisions indicator 502 may be displayed on the user interface 500 to signal the extent of user engagement with the content, potentially reflecting the amount of changes made during the editing process. These components may operate together to facilitate a structured alignment process, where users engage with the content through selection, editing, and instruction-based regeneration, ensuring that the final output aligns with the strategic goals of the project.

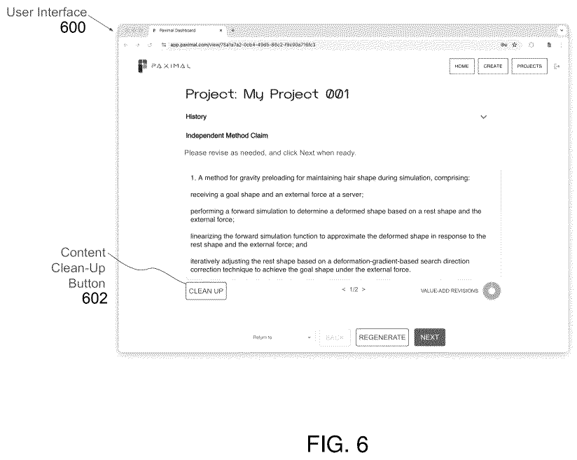

FIG. 6 shows user interface 600 which supports techniques for aligning auto-generated patent content with attorney intent in accordance with various aspects of the present disclosure. The user interface 600 may include interactive elements for aligning patent drafts with attorney input. In some implementations, the user interface 500 may be the same as or similar to the user interface 200, the user interface 300, the user interface 400, and/or the user interface 500, as described herein. As depicted in FIG. 6, the user interface 600 may include a content clean-up button 602 and/or other components.

The user interface 602 may include interactive elements for aligning patent drafts with attorney input. In some implementations, the user interface 602 may be the same as or similar to the user interface 502 and/or user interface 302, as described herein.

The content clean-up button 602 may include functionality to address basic errors in patent drafts. The content clean-up button 602 may be an interactive element that users can activate to correct common mistakes in the document. It may focus on errors related to Section 112 and other regulatory requirements. In some implementations, the content clean-up button 602 may work independently or in conjunction with automated proofreading tools. The content clean-up button 602 may be designed to streamline the editing process by quickly resolving issues that could affect the document's compliance.

In some implementations, the user interface 600 may serve as the primary platform through which users interact with the AI system. The user interface 600 may display various options and features, such as the content clean-up button 602, which may be used to address basic errors and ensure compliance with drafting conventions. The content clean-up button 602 may be integrated into the user interface 600 to allow users to initiate automatic corrections related to clarity, grammar, and formatting. In some implementations, the user interface 600 may facilitate the structured alignment process by presenting users with different versions of patent application sections, enabling them to select and refine content based on their expertise.

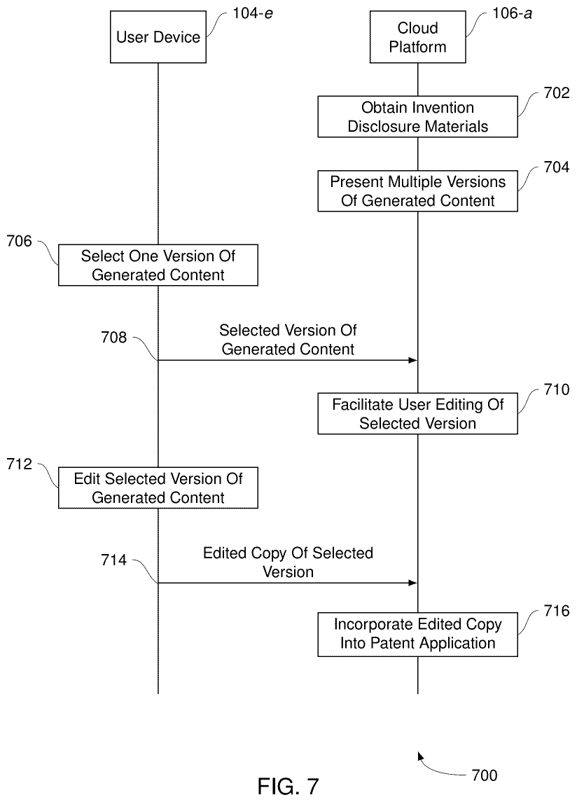

FIG. 7 illustrates an example of a process flow 700 that supports aligning auto-generated patent content with attorney intent in accordance with aspects of the present disclosure. In some examples, the process flow 700 may implement aspects of the system 100. For example, the process flow 700 may include a user device 104-e and a cloud platform 106-a, which may be examples of corresponding devices described herein. In some implementations, a cloud platform 106-a receives invention disclosure materials, presents multiple versions of generated content for selection, facilitates user editing of the selected version, and incorporates the edited content into an auto-generated patent application, while a user device 104-e interacts with the cloud platform 106-a to select and edit the generated content.

At 702, the cloud platform 106-a may obtain invention disclosure materials, the invention disclosure materials may include one or more documents that describe an invention. For example, the invention disclosure materials may consist of technical drawings, detailed descriptions, and potential claims that outline the scope of the invention. In some implementations, the cloud platform 106-a may receive these materials from a user device 104-e, which may upload the documents through a secure interface. The cloud platform 106-a may then store the invention disclosure materials in a database for further processing and analysis. In some implementations, the cloud platform 106-a may categorize the materials based on predefined criteria, such as technology domain or application area, to streamline subsequent steps in the patent drafting process.

At 704, the cloud platform 106-a may present multiple versions of generated content for selection, the multiple versions of generated content may include different versions of one or more of a target for protection, an independent claim, and/or one or more dependent claims. For example, a user device 104-e may receive two distinct versions of an independent claim, prompting the user to select the version that may align better with the intended protection strategy. In some implementations, the cloud platform 106-a may display variations of dependent claims that may emphasize different technical aspects, allowing the user to choose the most relevant ones. Additionally, the cloud platform 106-a may offer alternative phrasing for a target for protection, enabling the user to select the wording that may best capture the essence of the invention.

At 706, the user device 104-e may select one version of the generated content from the multiple versions presented by the cloud platform 106-a. For example, the user device 104-e may display two versions of an independent claim, prompting the user to choose the version that may align better with the intended protection strategy. In some implementations, the user device 104-e may present alternative phrasing for a target for protection, allowing the user to select the wording that may best capture the essence of the invention. The user device 104-e may also offer variations of dependent claims that may emphasize different technical aspects, enabling the user to choose the most relevant ones. In some implementations, the user device 104-e may provide a visual comparison tool to help the user evaluate the differences between the versions, aiding in the selection process.

At 708, the user device 104-e may transmit the selected version of the generated content to the cloud platform 106-a. For example, the user device 104-e may send a version of an independent claim that has been chosen by the user after reviewing multiple options. In some implementations, the user device 104-e may include metadata with the transmission, such as the user's comments or rationale for the selection, which may assist the cloud platform 106-a in further processing. In some implementations, the user device 104-e may encrypt the content before transmission to ensure secure delivery to the cloud platform 106-a.

At 710, the cloud platform 106-a may facilitate user editing of the selected version of the generated content. For example, the cloud platform 106-a may offer a user interface that allows a user device 104-e to make textual modifications to the selected version, such as adjusting phrasing or adding technical details. In some implementations, the cloud platform 106-a may provide tools for tracking changes, enabling the user device 104-e to view a history of edits and revert to previous versions if necessary. In some implementations, the cloud platform 106-a may include a feature that suggests alternative wording or technical terms based on the context of the selected version, assisting the user device 104-e in refining the content.

At 712, the user device 104-e may edit the selected version of the generated content as facilitated by the cloud platform 106-a. For example, the user device 104-e may adjust the language of the independent claim to better reflect the technical nuances of the subject matter. In some implementations, the user device 104-e may incorporate additional technical details into the dependent claims to enhance specificity. In some implementations, the user device 104-e may modify the phrasing of the target for protection to align more closely with the strategic goals of the project.

At 714, the user device 104-e may transmit the edited copy of the selected version of the generated content to the cloud platform 106-a. For example, the user device 104-e may include annotations or comments with the transmission to highlight specific changes made during the editing process. In some implementations, the user device 104-e may use a secure communication protocol to ensure the integrity and confidentiality of the transmitted content. In some implementations, the user device 104-e may send a notification to the cloud platform 106-a indicating that the edited content is ready for further review or processing.

At 716, the cloud platform 106-a may incorporate the edited copy of the selected version of the generated content into an auto-generated patent application. For example, the cloud platform 106-a may integrate the edited content into a structured template that may include sections such as background, summary, and claims. In some implementations, the cloud platform 106-a may determine the appropriate placement of the edited content within the patent application, ensuring that the technical details align with the corresponding sections. In some implementations, the cloud platform 106-a may cross-reference the edited content with other parts of the application to maintain consistency in terminology and descriptions.

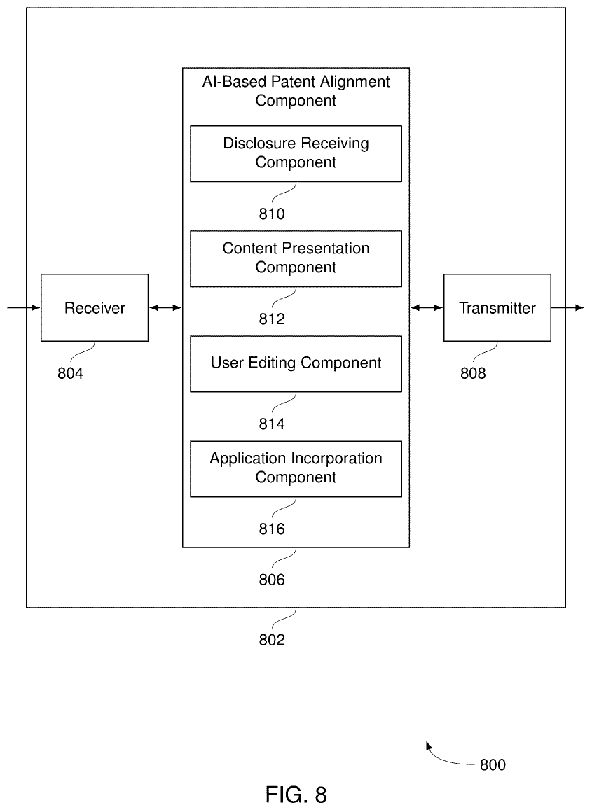

FIG. 8 shows a block diagram 800 of an apparatus 802 that supports aligning auto-generated patent content with attorney intent in accordance with various aspects of the present disclosure. The apparatus 802 may include an input module 804, AI-based patent alignment component 806, and an output module 808. The apparatus 802 may also include a processor. Each of these components may be in communication with one another (e.g., via one or more buses). In some cases, the apparatus 802 may be an example of a user terminal, a database server, or a system containing multiple computing devices.

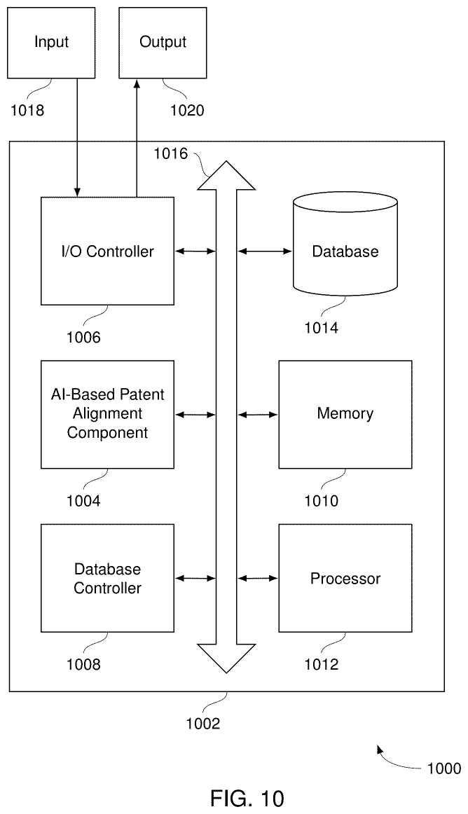

The input module 804 may manage input signals for the apparatus 802. For example, the input module 804 may identify input signals based on an interaction with a modem, a keyboard, a mouse, a touchscreen, or a similar device. These input signals may be associated with user input or processing at other components or devices. In some cases, the input module 804 may utilize an operating system such as iOS®, ANDROID®, MS-DOS®, MS-WINDOWS®, OS/2®, UNIX®, LINUX®, or another known operating system to handle input signals. The input module 804 may send aspects of these input signals to other components of the apparatus 802 for processing. In some cases, the input module 804 may be a component of an input/output (I/O) controller 1006 as described with reference to FIG. 10.

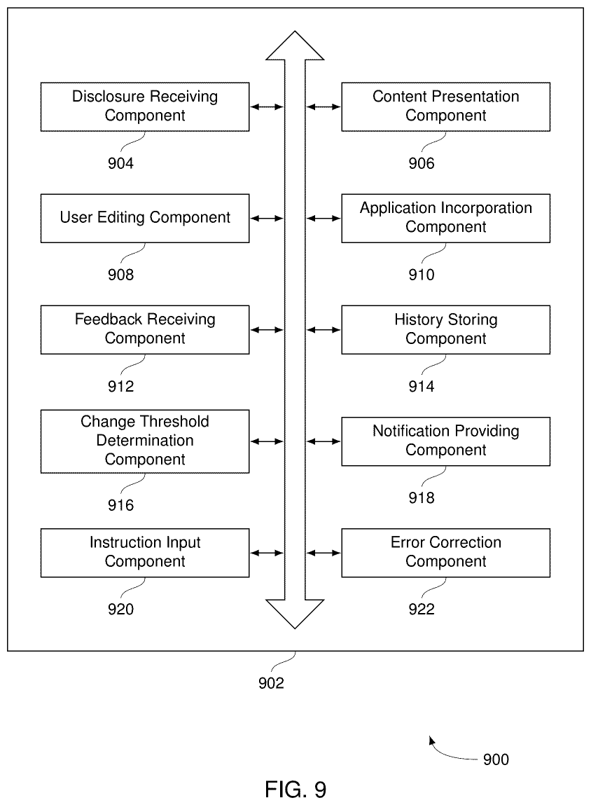

The AI-based patent alignment component 806 may include one or more of a disclosure receiving component 810, a content presentation component 812, a user editing component 814, an application incorporation component 816, and/or other components. The AI-based patent alignment component 806 may be an example of aspects of the AI-based patent alignment component 902 or 1004 described with reference to FIGS. 9 and 10.

The disclosure receiving component 810 may be configured as or otherwise support a means for receiving invention disclosure materials, the invention disclosure materials including one or more documents that describe an invention. The content presentation component 812 may be configured as or otherwise support a means for presenting multiple versions of generated content for selection, the multiple versions of generated content including different versions of one or more of a target for protection, an independent claim, and/or one or more dependent claims. The user editing component 814 may be configured as or otherwise support a means for facilitating user editing of a selected version of the generated content in response to receiving a selection of one version of the generated content. The application incorporation component 816 may be configured as or otherwise support a means for incorporating an edited copy of the selected version of the generated content into an auto-generated patent application.

The output module 808 may manage output signals for the apparatus 802. For example, the output module 808 may receive signals from other components of the apparatus 802, such as the AI-based patent alignment component 806, and may transmit these signals to other components or devices. In some specific examples, the output module 808 may transmit output signals for display in a user interface, for storage in a database or data store, for further processing at a server or server cluster, or for any other processes at any number of devices or systems. In some cases, the output module 808 may be a component of an I/O controller 1006 as described with reference to FIG. 10.

FIG. 9 shows a block diagram 900 of an AI-based patent alignment component 902 that supports aligning auto-generated patent content with attorney intent in accordance with various aspects of the present disclosure. The AI-based patent alignment component 902 may be an example of aspects of an AI-based patent alignment component 806, an AI-based patent alignment component 1004, or both, as described herein. The AI-based patent alignment component 902, or various components thereof, may be an example of means for performing various aspects of aligning auto-generated patent content with attorney intent as described herein. For example, the AI-based patent alignment component 902 may include one or more of a disclosure receiving component 904, a content presentation component 906, a user editing component 908, an application incorporation component 910, a feedback receiving component 912, a history storing component 914, a change threshold determination component 916, a notification providing component 918, an instruction input component 920, an error correction component 922, and/or other components. Each of these components may communicate, directly or indirectly, with one another (e.g., via one or more buses).

The disclosure receiving component 904 may be configured as or otherwise support a means for receiving invention disclosure materials, the invention disclosure materials including one or more documents that describe an invention. The disclosure receiving component 904 may include functionality to accept invention disclosure materials in various formats, such as text files, PDFs, or scanned images. In some implementations, the disclosure receiving component 904 may support integration with external systems to retrieve invention disclosure materials directly from a client database. The disclosure receiving component 904 may allow users to upload invention disclosure materials through a secure web interface, ensuring compatibility with multiple file types.

The content presentation component 906 may be configured as or otherwise support a means for presenting multiple versions of generated content for selection, the multiple versions of generated content may include different versions of one or more of a target for protection, an independent claim, and/or one or more dependent claims. In some implementations, the content presentation component 906 may present two versions of an independent claim to allow a user to select the one that aligns best with their strategic goals. The content presentation component 906 may include a feature that requires users to make a selection before proceeding, which may encourage thoughtful consideration of the content. In some implementations, the content presentation component 906 may display a message prompting the user to confirm their choice if minimal changes are detected, which may help ensure that the user has engaged with the content.

The user editing component 908 may be configured as or otherwise support a means for facilitating user editing of the selected version of the generated content in response to receiving a selection of one version of the generated content. In some implementations, the user editing component 908 may allow users to make changes to the text to align it with their specific requirements. The user editing component 908 may include features that track the amount of text modified to ensure that users engage with the content. In some implementations, the user editing component 908 may prompt users to confirm their edits if minimal changes are detected, which may encourage thorough review.

The application incorporation component 910 may be configured as or otherwise support a means for incorporating an edited copy of the selected version of the generated content into an auto-generated patent application. In some implementations, the application incorporation component 910 may integrate the edited content into a pre-defined template that includes sections such as background, summary, and claims. The application incorporation component 910 may include functionality to format the incorporated content to comply with jurisdiction-specific patent office requirements. In some implementations, the application incorporation component 910 may support the inclusion of metadata, such as filing dates or applicant information, alongside the incorporated content. The application incorporation component 910 may allow for the insertion of additional sections, such as detailed descriptions or examples, based on user-provided inputs.

In some examples, the feedback receiving component 912 may be configured as or otherwise support a means for receiving user feedback on the selected version of the generated content or instructions on revised that content, and may adjust the presentation of subsequent versions of generated content based on the user feedback to enhance alignment with attorney intent. In some implementations, the feedback receiving component 912 may include a user interface that allows users to rate the clarity and relevance of the content. The feedback receiving component 912 may incorporate a system for users to suggest alternative phrasing or additional details that may be included in future versions. In some implementations, the feedback receiving component 912 may analyze patterns in user feedback to determine common areas of concern or confusion.

In some examples, the history storing component 914 may be configured as or otherwise support a means for storing a history of user edits to the selected version of the generated content in a database, wherein the history may be accessible for reuse. In some implementations, the history storing component 914 may track the sequence of changes made by the user to understand the evolution of the document. The history storing component 914 may include timestamps for each edit to allow users to view the progression of changes over time. In some implementations, the history storing component 914 may categorize edits based on the type of modification, such as text insertion or deletion, to facilitate organized retrieval.

In some examples, the change threshold determination component 916 may be configured as or otherwise support a means for determining a threshold amount of changes made by the user to the selected independent claim, the changes may indicate user engagement with the content. In some implementations, the change threshold determination component 916 may determine the threshold based on a percentage of the total text length of the independent claim. In some implementations, the change threshold determination component 916 may determine the threshold by analyzing the frequency of edits made within a predefined time frame. In some implementations, the change threshold determination component 916 may determine the threshold by comparing the number of modified words to the total number of words in the independent claim.

In some examples, the notification providing component 918 may be configured as or otherwise support a means for providing a notification to the user in response to detecting that the user has not made a threshold amount of changes to the selected version of the generated content. In some implementations, the notification providing component 918 may present a pop-up message on the user's screen to alert them of the insufficient changes. In some implementations, the notification providing component 918 may send an email reminder to the user, prompting them to review and edit the content further. In some implementations, the notification providing component 918 may include an option for the user to acknowledge the notification and proceed with the current version if they believe no further changes are necessary.

In some examples, the instruction input component 920 may be configured as or otherwise support a means for enabling the user to input specific instructions for regenerating the selected version of the generated content, wherein the regenerated content may be accessible with previous versions for comparison and selection. In some implementations, the instruction input component 920 may allow users to specify particular areas of the text that require modification, such as technical terminology or phrasing. The instruction input component 920 may include a feature that prompts users to provide context or examples to guide the regeneration process. In some implementations, the instruction input component 920 may support the input of instructions through a structured form, which may include fields for detailed descriptions or objectives for the regenerated content.

In some examples, the error correction component 922 may be configured as or otherwise support a means for automatically correcting errors in the selected version of the generated content, the errors being related to one or both of drafting requirements or conventions. In some implementations, the error correction component 922 may detect formatting inconsistencies, such as incorrect indentation or line spacing, and adjust them to align with predefined standards. In some implementations, the error correction component 922 may identify and correct typographical errors, such as misspelled words or misplaced punctuation, based on a predefined dictionary or style guide. In some implementations, the error correction component 922 may determine whether the content includes incomplete sentences or phrases and suggest modifications to ensure grammatical accuracy.

FIG. 10 shows a diagram of a system 1000 including a device 1002 that supports aligning auto-generated patent content with attorney intent in accordance with aspects of the present disclosure. The device 1002 may be an example of or include the components of a database server or an apparatus 802 as described herein. The device 1002 may include components for bi-directional data communications including components for transmitting and receiving communications, including an AI-based patent alignment component 1004, an I/O controller 1006, a database controller 1008, memory 1010, a processor 1012, and a database 1014. These components may be in electronic communication via one or more buses (e.g., bus 1016).

The AI-based patent alignment component 1004 may be an example of an AI-based patent alignment component 806 or 902 as described herein. For example, the AI-based patent alignment component 1004 may perform any of the methods or processes described above with reference to FIGS. 8 and 9. In some cases, the AI-based patent alignment component 1004 may be implemented in hardware, software executed by a processor, firmware, or any combination thereof.

The I/O controller 1006 may manage input signals 1018 and output signals 1020 for the device 1002. The I/O controller 1006 may also manage peripherals not integrated into the device 1002. In some cases, the I/O controller 1006 may represent a physical connection or port to an external peripheral. In some cases, the I/O controller 1006 may utilize an operating system such as iOS®, ANDROID®, MS-DOS®, MS-WINDOWS®, OS/2®, UNIX®, LINUX®, or another known operating system. In other cases, the I/O controller 1006 may represent or interact with a modem, a keyboard, a mouse, a touchscreen, or a similar device. In some cases, the I/O controller 1006 may be implemented as part of a processor. In some cases, a user may interact with the device 1002 via the I/O controller 1006 or via hardware components controlled by the I/O controller 1006.

The database controller 1008 may manage data storage and processing in a database 1014. In some cases, a user may interact with the database controller 1008. In other cases, the database controller 1008 may operate automatically without user interaction. The database 1014 may be an example of a single database, a distributed database, multiple distributed databases, a data store, a data lake, or an emergency backup database.

Memory 1010 may include random-access memory (RAM) and read-only memory (ROM). The memory 1010 may store computer-readable, computer-executable software including instructions that, when executed, cause the processor to perform various functions described herein. In some cases, the memory 1010 may contain, among other things, a basic input/output system (BIOS) which may control basic hardware or software operation such as the interaction with peripheral components or devices.

The processor 1012 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1012 may be configured to operate a memory array using a memory controller. In other cases, a memory controller may be integrated into the processor 1012. The processor 1012 may be configured to execute computer-readable instructions stored in a memory 1010 to perform various functions (e.g., functions or tasks supporting aligning auto-generated patent content with attorney intent).

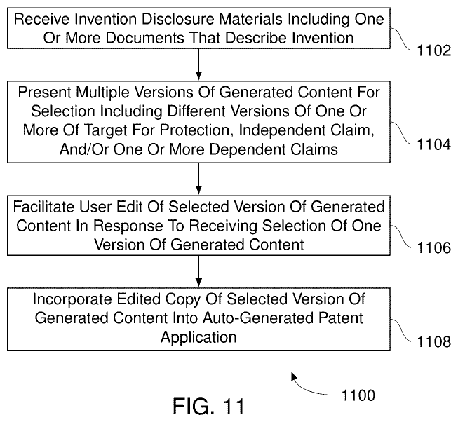

FIG. 11 shows a flowchart illustrating a method 1100 that supports aligning auto-generated patent content with attorney intent in accordance with various aspects of the present disclosure. The operations of the method 1100 may be implemented by one or more components of a networked computing system as described herein. For example, the operations of the method 1100 may be performed by an AI-based patent alignment component as described with reference to FIGS. 8 through 10. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1102, the method 1100 may include receiving invention disclosure materials, the invention disclosure materials including one or more documents that describe an invention. The operations of 1102 may be performed in accordance with examples as disclosed herein. In some examples, aspects of the operations of 1102 may be performed by a disclosure receiving component 904 as described with reference to FIG. 9.

At 1104, the method 1100 may include presenting multiple versions of generated content for selection, the multiple versions of generated content including different versions of one or more of a target for protection, an independent claim, and/or one or more dependent claims. The operations of 1104 may be performed in accordance with examples as disclosed herein. In some examples, aspects of the operations of 1104 may be performed by a content presentation component 906 as described with reference to FIG. 9.

At 1106, the method 1100 may include, in response to receiving a selection of one version of the generated content, facilitating user editing of the selected version of the generated content. The operations of 1106 may be performed in accordance with examples as disclosed herein. In some examples, aspects of the operations of 1106 may be performed by a user editing component 908 as described with reference to FIG. 9.

At 1108, the method 1100 may include incorporating an edited copy of the selected version of the generated content into an auto-generated patent application. The operations of 1108 may be performed in accordance with examples as disclosed herein. In some examples, aspects of the operations of 1108 may be performed by an application incorporation component 910 as described with reference to FIG. 9.

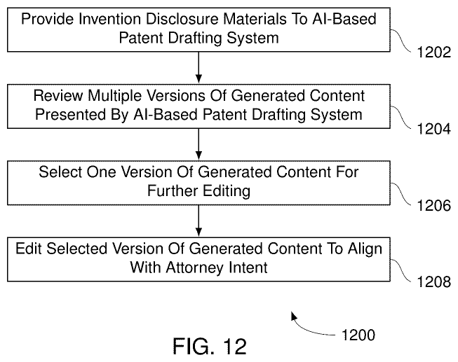

FIG. 12 shows a flowchart illustrating a method 1200 that supports aligning auto-generated patent content with attorney intent in accordance with various aspects of the present disclosure. The operations of the method 1200 may be implemented by one or more components of a networked computing system as described herein. For example, the operations of the method 1200 may be performed by an AI-based patent alignment component as described with reference to FIGS. 8 through 10. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1202, the method 1200 may include providing invention disclosure materials to an AI-based patent drafting system, the invention disclosure materials including one or more documents that describe an invention. The operations of 1202 may be performed in accordance with examples as disclosed herein. In some examples, aspects of the operations of 1202 may be performed by a disclosure receiving component 904 as described with reference to FIG. 9.

At 1204, the method 1200 may include reviewing multiple versions of generated content presented by the AI-based patent drafting system, the multiple versions of generated content including different versions of one or more of a target for protection, an independent claim, and/or one or more dependent claims. The operations of 1204 may be performed in accordance with examples as disclosed herein. In some examples, aspects of the operations of 1204 may be performed by a content presentation component 906 as described with reference to FIG. 9.

At 1206, the method 1200 may include selecting one version of the generated content for further editing. The operations of 1206 may be performed in accordance with examples as disclosed herein. In some examples, aspects of the operations of 1206 may be performed by a user editing component 908 as described with reference to FIG. 9.

At 1208, the method 1200 may include editing the selected version of the generated content to align with attorney intent before incorporating it into an auto-generated patent application. The operations of 1208 may be performed in accordance with examples as disclosed herein. In some examples, aspects of the operations of 1208 may be performed by an application incorporation component 910 as described with reference to FIG. 9.

It should be noted that the methods described herein describe possible implementations, and that the operations and the steps may be rearranged or otherwise modified and that other implementations are possible. Furthermore, aspects from two or more of the methods may be combined.
Aspect 1: A method for aligning AI-based patent drafting with attorney intent, comprising: receiving invention disclosure materials, the invention disclosure materials including one or more documents that describe an invention; presenting multiple versions of generated content for selection, the multiple versions of generated content including different versions of one or more of a target for protection, an independent claim, and/or one or more dependent claims; in response to receiving a selection of one version of the generated content, facilitating user editing of the selected version of the generated content; and incorporating an edited copy of the selected version of the generated content into an auto-generated patent application.
Aspect 2: The method of aspect 1, further comprising receiving user feedback on the selected version of the generated content and adjusting the presentation of subsequent versions of generated content based on the user feedback to enhance alignment with attorney intent.
Aspect 3: The method of any of aspects 1 through 2, further comprising storing a history of user edits to the selected version of the generated content in a database, wherein the history is accessible for reuse.
Aspect 4: The method of any of aspects 1 through 3, further comprising determining a threshold amount of changes made by the user to the selected independent claim, the changes indicating user engagement with the content.
Aspect 5: The method of any of aspects 1 through 4, further comprising providing a notification to the user in response to detecting that the user has not made a threshold amount of changes to the selected version of the generated content.
Aspect 6: The method of any of aspects 1 through 5, further comprising enabling the user to input specific instructions for regenerating the selected version of the generated content, wherein the regenerated content is accessible with previous versions for comparison and selection.
Aspect 7: The method of any of aspects 1 through 6, further comprising automatically correcting errors in the selected version of the generated content, the errors being related to one or both of drafting requirements or conventions.
Aspect 8: The method of any of aspects 1 through 7, wherein the invention disclosure materials include multimedia files that provide visual context for the invention.
Aspect 9: The method of any of aspects 1 through 8, wherein the user editing interface includes tools for annotating the selected version of the generated content.
Aspect 10: The method of any of aspects 1 through 9, wherein the presentation of multiple versions of generated content includes a scoring system that ranks the versions based on alignment with user preferences.
Aspect 11: The method of any of aspects 1 through 10, wherein the auto-generated patent application includes a summary section that highlights key features of the invention disclosure materials.
Aspect 12: A system for aligning AI-based patent drafting with attorney intent, comprising a processor; memory coupled with the processor; and instructions stored in the memory and executable by the processor to cause the system to perform a method of any of aspects 1 through 11.
Aspect 13: A system for aligning AI-based patent drafting with attorney intent, comprising at least one means for performing a method of any of aspects 1 through 11.
Aspect 14: A non-transitory computer-readable medium storing code for aligning AI-based patent drafting with attorney intent, the code comprising instructions executable by a processor to perform a method of any of aspects 1 through 11.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for aligning AI-based patent drafting with attorney intent, comprising:
receiving invention disclosure materials, the invention disclosure materials including one or more documents that describe an invention;
presenting multiple versions of generated content for selection, the multiple versions of generated content including different versions of one or more of a target for protection, an independent claim, and/or one or more dependent claims;
in response to receiving a selection of one version of the generated content, facilitating user editing of the selected version of the generated content; and
incorporating an edited copy of the selected version of the generated content into an auto-generated patent application.

2. The method of claim 1, further comprising receiving user feedback on the selected version of the generated content and adjusting the presentation of subsequent versions of generated content based on the user feedback to enhance alignment with attorney intent.

3. The method of claim 1, further comprising storing a history of user edits to the selected version of the generated content in a database, wherein the history is accessible for reuse.

4. The method of claim 1, further comprising determining a threshold amount of changes made by the user to the selected independent claim, the changes indicating user engagement with the content.

5. The method of claim 4, further comprising providing a notification to the user in response to detecting that the user has not made a threshold amount of changes to the selected version of the generated content.

6. The method of claim 1, further comprising enabling the user to input specific instructions for regenerating the selected version of the generated content, wherein the regenerated content is accessible with previous versions for comparison and selection.

7. The method of claim 1, further comprising automatically correcting errors in the selected version of the generated content, the errors being related to one or both of drafting requirements or conventions.

8. The method of claim 1, wherein the invention disclosure materials include multimedia files that provide visual context for the invention.

9. The method of claim 1, wherein the user editing interface includes tools for annotating the selected version of the generated content.

10. The method of claim 1, wherein the presentation of multiple versions of generated content includes a scoring system that ranks the versions based on alignment with user preferences.

11. The method of claim 1, wherein the auto-generated patent application includes a summary section that highlights key features of the invention disclosure materials.

12. A system configured for aligning AI-based patent drafting with attorney intent, comprising:
a processor;
memory coupled with the processor; and
instructions stored in the memory and executable by the processor to cause the system to:
receive invention disclosure materials, the invention disclosure materials including one or more documents that describe an invention;
present multiple versions of generated content for selection, the multiple versions of generated content including different versions of one or more of a target for protection, an independent claim, and/or one or more dependent claims;
facilitate user editing of the selected version of the generated content in response to receiving a selection of one version of the generated content; and
incorporate an edited copy of the selected version of the generated content into an auto-generated patent application.

13. The system of claim 12, wherein the instructions are further executable by the processor to cause the system to: receive user feedback on the selected version of the generated content and adjust the presentation of subsequent versions of generated content based on the user feedback to enhance alignment with attorney intent.

14. The system of claim 12, wherein the instructions are further executable by the processor to cause the system to: store a history of user edits to the selected version of the generated content in a database, wherein the history is accessible for reuse.

15. The system of claim 12, wherein the instructions are further executable by the processor to cause the system to: determine a threshold amount of changes made by the user to the selected independent claim, the changes indicating user engagement with the content.

16. The system of claim 12, wherein the instructions are further executable by the processor to cause the system to: provide a notification to the user in response to detecting that the user has not made a threshold amount of changes to the selected version of the generated content.

17. The system of claim 12, wherein the instructions are further executable by the processor to cause the system to: enable the user to input specific instructions for regenerating the selected version of the generated content, wherein the regenerated content is accessible with previous versions for comparison and selection.

18. The system of claim 12, wherein the instructions are further executable by the processor to cause the system to: automatically correct errors in the selected version of the generated content, the errors being related to one or both of drafting requirements or conventions.

19. The system of claim 12, wherein the invention disclosure materials include multimedia files that provide visual context for the invention.

20. A non-transitory computer-readable medium storing code for aligning AI-based patent drafting with attorney intent, the code comprising instructions executable by a processor to:
receive invention disclosure materials, the invention disclosure materials including one or more documents that describe an invention;
present multiple versions of generated content for selection, the multiple versions of generated content including different versions of one or more of a target for protection, an independent claim, and/or one or more dependent claims;
in response to receiving a selection of one version of the generated content, facilitate user editing of the selected version of the generated content; and
incorporate an edited copy of the selected version of the generated content into an auto-generated patent application.
